(19) United States
(12) Patent Application Publication
(10) Pub. No.: US 2024/0231138 A9
(43) Pub. Date: Jul. 11, 2024

(54) LIQUID CRYSTAL GRATING AND DRIVING METHOD THEREOF, AND THREE-DIMENSIONAL DISPLAY DEVICE

(71) Applicant: Shanghai Tianma Microelectronics Co., Ltd., Shanghai (CN)

(72) Inventor: Yang ZENG, Shanghai (CN)

(73) Assignee: Shanghai Tianma Microelectronics Co., Ltd., Shanghai (CN)

(21) Appl. No.: 18/403,215

(22) Filed: Jan. 3, 2024

(30) Foreign Application Priority Data
Mar. 31, 2023 (CN) 202310342774.1

(51) Int. Cl. G02F 1/133; G02B 30/31

(52) U.S. Cl. CPC G02F 1/13306; G02B 30/31

(57) ABSTRACT

Provided are a liquid crystal grating and a driving method thereof, and a three-dimensional display device. The liquid crystal grating is configured to modulate incident light and output deflected emitted light. The incident light includes at least first incident light and second incident light. First emitted light is output after the first incident light is modulated by the liquid crystal grating. Second emitted light is output after the second incident light is modulated by the liquid crystal grating. The light wave segment of the first incident light and the light wave segment of the second incident light do not overlap at least partially. When the liquid crystal grating modulates the first incident light and the second incident light, at least one of the minimum value of a corresponding modulation voltage or the modulation duration is different.

### CROSS-REFERENCE TO RELATED APPLICATION

This application claims priority to Chinese Patent Application No. 202310342774.1 filed Mar. 31, 2023, the disclosure of which is incorporated herein by reference in its entirety.

### TECHNICAL FIELD

Embodiments of the present invention relate to display technology and, in particular, to a liquid crystal grating and a driving method thereof, and a three-dimensional display device.

### BACKGROUND

With the development of display technology, various display devices emerge constantly. To satisfy the use requirements of people for stereoscopic display of display devices, three-dimensional display becomes an important development direction in the current display field.

In the existing naked eye three-dimensional display device, the transmission direction of light is generally modulated by a liquid crystal grating to form a left-eye image and a right-eye image that are transmitted to human eyes. One frame of image needs to be modulated twice to form a left-eye image and a right-eye image respectively during three-dimensional display. In addition, red, green, and blue light need to be modulated for color display, and the operating frequency of a liquid crystal grating is very high. As a result, the existing liquid crystal grating has the problem of insufficient response, which affects the display effect.

### SUMMARY

Embodiments of the present invention embodiment provide a liquid crystal grating and a driving method thereof, and a three-dimensional display device.

In a first aspect, an embodiment of the present invention provides a liquid crystal grating. The liquid crystal grating is configured to modulate incident light and output deflected emitted light.

The incident light includes at least first incident light and second incident light. First emitted light is output after the first incident light is modulated by the liquid crystal grating. Second emitted light is output after the second incident light is modulated by the liquid crystal grating. The light wave segment of the first incident light and the light wave segment of the second incident light do not overlap at least partially.

When the liquid crystal grating modulates the first incident light and the second incident light, at least one of a minimum value of a modulation voltage corresponding to the first incident light and a minimum value of a modulation voltage corresponding to the second incident light or modulation duration corresponding to the first incident light and modulation duration corresponding to the second incident light is different.

In a second aspect, an embodiment of the present invention provides a driving method of a liquid crystal grating. The method is applied to the preceding liquid crystal grating. The liquid crystal grating includes multiple grating groups. Each grating group includes multiple drive electrodes. An odd-numbered drive electrode in the same grating group is connected to a first signal terminal. An even-numbered drive electrode is connected to a second signal terminal. Each drive electrode is connected to a corresponding drive voltage terminal.

When the incident light is modulated, a first stage in which the corresponding modulation voltage is written to the drive electrodes is included. The first stage includes a precharge stage and a gradient voltage write stage.

The driving method includes the steps below.

In the precharge stage, the first signal terminal applies a first precharge voltage to the corresponding drive electrode, and the second signal terminal applies a second precharge voltage to the corresponding drive electrode.

In the gradient voltage write stage, the drive voltage terminal applies a gradient voltage to the corresponding drive electrode.

The first precharge voltage is the same as the second precharge voltage and is the same as the minimum voltage of the gradient voltage.

In a third aspect, an embodiment of the present invention provides a three-dimensional display device. The device includes a backlight module, a spatial light modulator, and the preceding liquid crystal grating that are sequentially stacked.

The backlight module is configured to provide field-sequential collimation coherent backlight required for three-dimensional display.

The spatial light modulator is configured to modulate the phase and amplitude of the field-sequential collimation coherent backlight.

The liquid crystal grating is configured to modulate the light beam output by the spatial light modulator into a first direction light beam and a second direction light beam and output the first direction light beam and the second direction light beam.

### BRIEF DESCRIPTION OF DRAWINGS

FIG. 1 is a diagram illustrating the structure of a three-dimensional display device according to an embodiment of the present invention.

FIG. 2 is a diagram of the driving principle of the three-dimensional display device shown in FIG. 1.

FIG. 3 is a diagram illustrating the structure of a liquid crystal grating according to an embodiment of the present invention.

FIG. 4 is a timing diagram defined by the modulation duration of a liquid crystal grating according to an embodiment of the present invention.

FIG. 5 is a diagram of the driving principle of a three-dimensional display device according to an embodiment of the present invention.

FIG. 6 is a diagram of the driving principle of another three-dimensional display device according to an embodiment of the present invention.

FIG. 7 is a diagram of the drive timing of a liquid crystal grating according to an embodiment of the present invention.

FIG. 8 is a diagram of the driving principle of another three-dimensional display device according to an embodiment of the present invention.

FIG. 9 is a diagram of the drive timing of a liquid crystal grating according to an embodiment of the present invention.

FIG. 10 is a diagram of the driving principle of another three-dimensional display device according to an embodiment of the present invention.

FIG. 11 is a diagram of the driving principle of another three-dimensional display device according to an embodiment of the present invention.

FIG. 12 is a diagram of a gradient voltage range loaded by a drive electrode according to an embodiment of the present invention.

FIG. 13 is a diagram of another gradient voltage range loaded by a drive electrode according to an embodiment of the present invention.

FIG. 14 is a diagram of the circuit principle of a grating group according to an embodiment of the present invention.

FIG. 15 is a principle diagram of loading a voltage by a liquid crystal grating according to an embodiment of the present invention.

FIG. 16 is a timing diagram of loading a voltage by a liquid crystal grating according to an embodiment of the present invention.

### DETAILED DESCRIPTION

Hereinafter the present invention is further described in detail in conjunction with the drawings and embodiments. It is to be understood that the specific embodiments set forth below are intended to illustrate and not to limit the present invention. Additionally, it is to be noted that, for ease of description, only part, not all, of structures related to the present invention are illustrated in the drawings.

Terms used in the embodiments of the present invention are merely used to describe the specific embodiments and not intended to limit the present invention. It is to be noted that spatially related terms, including “on”, “below”, “left” and “right” described in the embodiments of the present invention, are described from the perspective of the drawings and are not to be construed as a limitation to the embodiments of the present invention. Additionally, in the context, it is to be understood that when an element is formed “on” or “below” another element, the element may be directly formed “on” or “below” another element, or may be indirectly formed “on” or “below” another element via an intermediate element. The terms “first”, “second” and the like are merely used for description and used to distinguish between different components rather than indicate any order, quantity, or importance. For those of ordinary skill in the art, the preceding terms can be construed according to specific situations in the present invention.

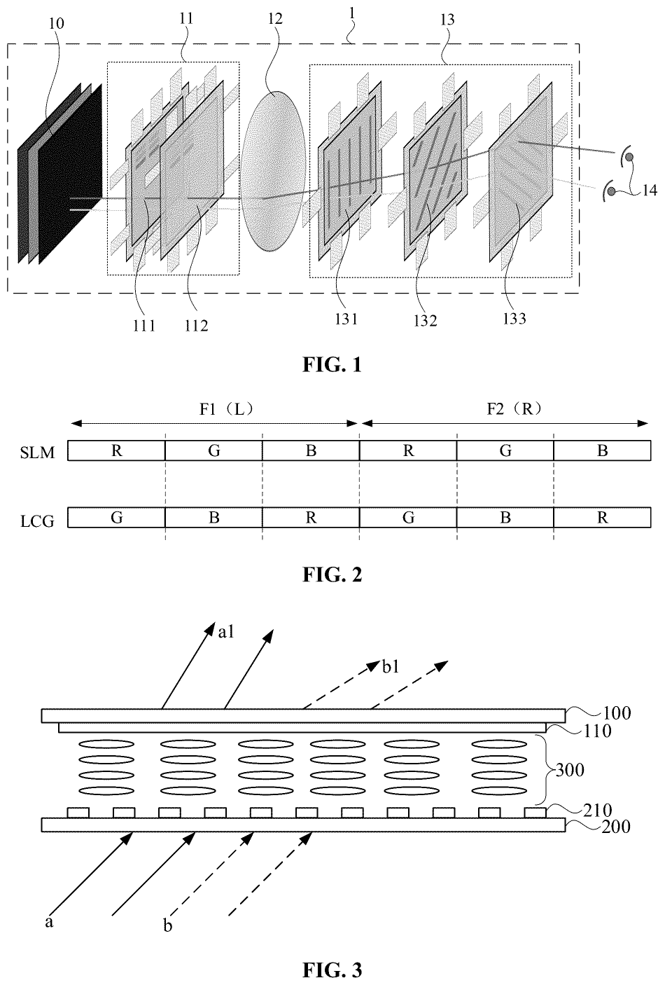

FIG. 1 is a diagram illustrating the structure of a three-dimensional display device according to an embodiment of the present invention. Referring to FIG. 1, the three-dimensional display device 1 may include a backlight module 10, a spatial light modulator 11, a convergence field lens 12, and a liquid crystal grating 13 that are sequentially stacked. The backlight module 10 is configured to provide a field-sequential collimation coherent light beam required for three-dimensional display. A structure such as a light source and a beam expansion collimation assembly may be disposed in the backlight module 10 (the specific structure of the backlight module 10 is not shown in FIG. 1). For example, for color display, the light source may provide red (R) light, green (G) light, and blue (B) light that are coherent with the field sequence. The beam expansion collimation assembly performs beam expansion and collimation processing on the light emitted by the light source and then transmits the light to the spatial light modulator 11. The spatial light modulator 11 is disposed on a side of the backlight module 10 adjacent to human eyes 14 and configured to modulate the phase and amplitude of the field-sequential collimation coherent light beam. Specifically, the spatial light modulator 11 may include a phase spatial light modulator 111 and an amplitude spatial light modulator 112. The phase spatial light modulator 111 is configured to adjust the phase of the field-sequential collimation coherent light beam. The amplitude spatial light modulator 112 is configured to adjust the amplitude of the field-sequential collimation coherent light beam. The phase spatial light modulator 111 and the amplitude spatial light modulator 112 may be liquid crystal panel structures, and the detailed structures are not repeated here. The convergence field lens 12 may include at least one lens and is configured to converge the modulated field-sequential collimation coherent light beam to the liquid crystal grating 13. In this manner, the capability of the edge light of the modulated field-sequential collimation coherent light beam emitted by the spatial light modulator 11 to be incident to the liquid crystal grating 13 is improved. The liquid crystal grating 13 is configured to adjust the transmission direction of a light beam and transmit the left-eye image and the right-eye image in a three-dimensional optical image to the human eyes 14, so that the human eyes 14 can observe the three-dimensional image. The liquid crystal grating 13 may be provided with multiple liquid crystal modules that have different alignment directions. For example, FIG. 1 shows three liquid crystal modules, in the transmission direction of the light, that is, a first liquid crystal grating 131, a second liquid crystal grating 132, and a third liquid crystal grating 133 respectively. The grating alignment direction of the first liquid crystal grating 131, the grating alignment direction of the second liquid crystal grating 132, and the grating alignment direction of the third liquid crystal grating 133 may be 0 degree, 45 degrees, and 45 degrees respectively (the grating direction of the second liquid crystal grating 132 is perpendicular to the grating direction of the third liquid crystal grating 133). The above is only an optional disposition method of the liquid crystal grating 13, and the liquid crystal grating 13 may be disposed according to actual requirements during the specific implementation.

FIG. 2 is a diagram of the driving principle of the three-dimensional display device shown in FIG. 1. For simplicity, FIG. 2 shows only the drive timing of a spatial light modulator (SLM) and the drive timing of a liquid crystal grating (LCG). In an actual driving process, drive signals loaded by different SLMs or different LCGs are different. The timing of the loaded signals is the same. Thus, only one SLM and one LCG are shown in the driving principle diagram. It is to be understood that since a left-eye image and a right-eye image are displayed separately during three-dimensional display, and to observe a display image of 60 Hz by using the human eyes, the frequency of the left-eye image and the frequency of the right-eye image need to reach 60 Hz, the drive frequency of the SLM needs to reach 120 Hz. Three-color light of R light, G light, and B light need to be modulated separately during color display. Since the wavelengths of the three light are different, and the LCG does not include pixel design, to implement the same deflection effect, the LCG needs to be modulated separately for different light. Thus, the modulation frequency of the LCG needs to reach 360 Hz.

For example, FIG. 2 shows a timing diagram of two frames of images. The two frames of images may be understood as follows: The first frame is a left-eye image and is represented by F1 (L), and the second frame is a right-eye image and is represented by F2 (R). The human eyes may observe a complete three-dimensional image after scanning. It is to be noted that in this embodiment, the selected SLM is a liquid crystal spatial light modulator. The SLM is similar to the structure of a liquid crystal display panel. The difference is that the pixel arrangement of the SLM is different from the pixel arrangement of an ordinary liquid crystal display panel. Generally, the pixel arrangement in the ordinary liquid crystal display panel is that a red sub-pixel, a green sub-pixel, and a blue sub-pixel are arranged alternately in the row direction, and the sub-pixels in the column direction have the same color. In the SLM, one row has only one color of sub-pixels. For example, red sub-pixels are rows 1, 4, 7, and . . . , green sub-pixels are rows 2, 5, 8, and . . . , and blue sub-pixels are rows 3, 6, 9, and . . . During three-dimensional display, the backlight of colors of R, G, and B is sequentially modulated. In FIG. 2, the first row and the second row represent the timing of the SLM and the timing of the LCG respectively. R, G, and B in the first row refer to performing row-by-row scanning on and applying a drive voltage to the pixel electrode corresponding to the red (R) sub-pixel, the pixel electrode corresponding to the green (G) sub-pixel, and the pixel electrode corresponding to the blue (B) sub-pixel in the SLM respectively. R, G, and B in the second row refer to the time period when the LCG modulates the three-color light of R light, G light, and B light. Since there is no pixel structure in the LCG, modulation needs to be performed on each to-be-transmitted light. Thus, for the three-color light of R light, G light, and B light, the modulation frequency of the LCG is three times that of the SLM. That is, a group of R, G, and B in the first row represents three time periods in one frame when the SLM is modulated, and a group of G, B, and R in the second row represents that one frame includes three subframes when the LCG is modulated.

The LCG needs to operate at a high frequency (when the human eyes see 60 Hz, the drive frequency of the LCG is 360 Hz). The LCG is a liquid crystal device. Due to reasons such as high viscosity of liquid crystals, in the related art, there is a problem that the display effect is affected by the insufficient response of liquid crystals.

To solve the preceding problem, this embodiment of the present invention provides a liquid crystal grating that may be applied to the three-dimensional display device. The liquid crystal grating is configured to modulate incident light and output deflected emitted light. The incident light includes at least first incident light and second incident light. First emitted light is output after the first incident light is modulated by the liquid crystal grating. Second emitted light is output after the second incident light is modulated by the liquid crystal grating. The light wave segment of the first incident light and the light wave segment of the second incident light do not overlap at least partially. When the liquid crystal grating modulates the first incident light and the second incident light, at least one of the minimum value of a corresponding modulation voltage or the modulation duration is different. When the liquid crystal grating modulates different incident light, at least one of the minimum value of the corresponding modulation voltage or the modulation duration is different. In this manner, the high-frequency modulation performance of the liquid crystal grating is optimized, and the display effect is improved.

The above is the core idea of the embodiments of the present invention, and the specific embodiments of the present invention are described below in conjunction with the drawings.

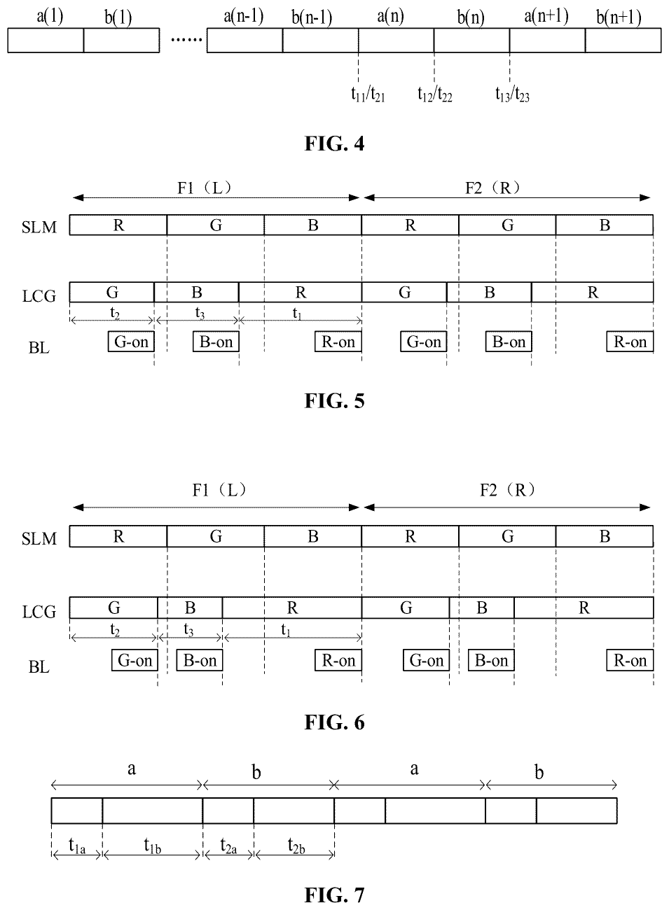

FIG. 3 is a diagram illustrating the structure of a liquid crystal grating according to an embodiment of the present invention. Referring to FIG. 3, the liquid crystal grating includes a first substrate 100, a second substrate 200, and a liquid crystal layer 300 located between the first substrate 100 and the second substrate 200. A first electrode 110 (common electrode) is disposed on a side of the first substrate 100. Multiple second electrodes 120 are disposed on a side of the second substrate 200. When different modulation voltages are loaded between the first electrode 110 and the second electrodes 120, liquid crystal molecules may be rotated to different directions to modulate light. Specifically, multiple second electrodes 120 form one electrode group. Each electrode group, the first electrode 110 of a corresponding region, and the liquid crystal layer between the electrode group and the first electrode 110 form one grating group (one period of the grating) in the liquid crystal grating. Multiple electrode groups are disposed in the entire liquid crystal grating structure. When the liquid crystal grating is driven, the electrode in each electrode group applies a corresponding gradient voltage, and liquid crystal molecules in the liquid crystal layer 300 may be periodically arranged to form a liquid crystal grating for modulating light. For example, the incident light includes at least first incident light a and second incident light b, such as red light and green light. First emitted light al is output after the first incident light a is modulated by the liquid crystal grating. Second emitted light b1 is output after the second incident light b is modulated by the liquid crystal grating. For example, FIG. 3 shows that the liquid crystal grating is in the same state. The transmission direction of the first emitted light a1 and the transmission direction of the second emitted light b1 are different. In other embodiments, when the first incident light and the second incident light are modulated, the liquid crystal may be in different states, so that transmission directions of the two output light are the same. During specific implementation, different electrode groups may include the same number of second electrodes 120 or may also include different numbers of second electrodes 120. This is not limited in this embodiment of the present invention.

It is to be understood that when the liquid crystal grating operates, it is necessary to control a modulation voltage to drive the phase of a liquid crystal molecule to change in the range of 0˜2π. The inventors find that when light of different wavelengths is modulated, a voltage required for a liquid crystal phase to change 2π is different. In addition, when light is modulated, only the phase change of a liquid crystal molecule is required to reach a (when the liquid crystal grating operates, the effect of the phase of a liquid crystal molecule in 0˜2π or π˜3π is equivalent). The greater the drive voltage is, the faster the liquid crystal response is. When the liquid crystal grating modulates incident light of different wavelengths, the minimum value of the corresponding modulation voltage is different. In this manner, it is beneficial to improve the response speed of liquid crystals, and the high-frequency modulation performance of the liquid crystal grating is optimized. In another aspect, when the liquid crystal grating modulates different incident light, the response speed of the liquid crystals is different. Thus, different modulation duration may be set, or the modulation voltage and the modulation duration are changed simultaneously. A design may be performed according to actual situations during the specific implementation.

In an embodiment, the modulation period of the liquid crystal grating includes multiple subframes. The modulation duration of incident light corresponds to the duration of one subframe. The end moment of the Nth subframe is the same as the start moment of the (N+1)th subframe, and N is an integer ≥2.

The modulation period of the liquid crystal grating is the display period of one display image. For example, for the three-dimensional display device including three-color light of R light, G light, and B light, one modulation period includes a left-eye image and a right-eye image that modulate the three-color light of R light, G light, and B light. For example, FIG. 2 shows one modulation period. For example, the liquid crystal grating modulates two types of incident light.

For example, the liquid crystal grating modulates two types of incident light. FIG. 4 is a timing diagram defined by the modulation duration of a liquid crystal grating according to an embodiment of the present invention. Referring to FIG. 4, the liquid crystal grating modulates the first incident light a and the second incident light b alternately for multiple times and modulates the first incident light a for the first time. The modulation start moment corresponding to the nth modulation of the first incident light a is t₁₁, the modulation end moment of the (n−1)th modulation of the second incident light b is t₂₁, and t₁₁=t₂₁. The modulation end moment corresponding to the nth modulation of the first incident light a is t₁₂, the modulation start moment of the nth modulation of the second incident light b is t₂₂, and t₁₂=t₂₂. The modulation end moment of the nth modulation of the second incident light b is t₂₃, and the modulation start moment of the (n+1)th modulation of the first incident light a is t₁₃, and t₂₃=t₁₃, where N is an integer greater than 1.

It is to be understood that if there are more than two types of incident light that needs to be modulated, for example, three-color light of R light, G light, and B light is sequentially modulated, the end moment of the modulation of the R light is the same as the start moment of the modulation of the next G light, the end moment of the modulation of the G light is the same as the start moment of the modulation of the next B light, and the end moment of the modulation of the B light is the same as the start moment of the modulation of the next R light.

In an embodiment, the first incident light and the second incident light satisfy: λ₁>λ₂.

The modulation duration satisfies: t₁>t₂.

λ₁ denotes the center wavelength of the first incident light. λ₂ denotes the center wavelength of the second incident light. t₁ denotes the modulation duration for modulating the first incident light. t₂ denotes the modulation duration for modulating the second incident light.

It is to be understood that when λ₁>λ₂, a normal liquid crystal material satisfies

$$\frac{Δ n ( {λ}_{1} )}{{λ}_{1}} < \frac{Δ n ( {λ}_{2} )}{{λ}_{2}} .$$

Δn (λ₁) denotes the refractive index difference of the liquid crystal in the liquid crystal grating to the birefringence of the first incident light. Δn (λ₂) denotes the refractive index difference of the liquid crystal in the liquid crystal grating to the birefringence of the second incident light. In the same liquid crystal state, the phase corresponding to the first incident light modulated by the liquid crystal grating is less than the phase of the second incident light modulated by the liquid crystal grating. In other words, if the first incident light and the second incident light reach the same phase, a liquid crystal deflection angle is greater when the first incident light is modulated. Thus, a liquid crystal response speed when the first incident light is modulated is less than a liquid crystal response speed when the second incident light is modulated. In this embodiment, t₁>t₂, t₁=t₁₂−t₁₁, and t₂=t₂₃−t₂₂ are set, that is, more modulation time is reserved when the first incident light is modulated, and the modulation process of the liquid crystal grating is optimized.

It is to be noted that in another embodiment, if the liquid crystal material satisfies

$$\frac{Δ n ( {λ}_{1} )}{{λ}_{1}} < \frac{Δ n ( {λ}_{2} )}{{λ}_{2}} ,$$

t₁<t₂ needs to be set. The principle is similar to the principle of the preceding embodiment, and the details are not repeated here. In this embodiment, for example, the liquid crystal material satisfies

$$\frac{Δ n ( {λ}_{1} )}{{λ}_{1}} < \frac{Δ n ( {λ}_{2} )}{{λ}_{2}} .$$

In an embodiment, the incident light includes first incident light, second incident light, and third incident light. The first incident light, the second incident light, and the third incident light satisfy: λ₁>λ₂>λ₃.

The modulation duration satisfies: t₁>t₂, and t₁>t₃.

λ₁ denotes the center wavelength of the first incident light. λ₂ denotes the center wavelength of the second incident light. λ₃ denotes the center wavelength of the third incident light. t₁ denotes the modulation duration for modulating the first incident light. t₂ denotes the modulation duration for modulating the second incident light. t₃ denotes the modulation duration for modulating the third incident light.

The first incident light may be R light. The second incident light may be G light. The third incident light may be B light. For example, the center wavelength of commonly used R light, the center wavelength of commonly used G light, and the center wavelength of commonly used B light are 638 nm, 532 nm, and 442 nm respectively. Since the liquid crystal grating may be applied to the three-dimensional display device, FIG. 5 is a diagram of the driving principle of a three-dimensional display device according to an embodiment of the present invention. Referring to FIG. 5, in this embodiment, the modulation duration satisfies: t₁>t₂, and t₁>t₃.

It is to be understood that since the liquid crystal response is the slowest, when the R light is modulated, in this embodiment, t₁ is increased, that is, more time is allocated to an R subframe in an entire frame, so that the liquid crystal has enough time. The backlight enabling time may be adaptively adjusted according to the timing of the LCG. Since the time of each subframe of the SLM is relatively long, the time may be set to the same length, that is, the same as the length in the related art, so that the drive timing of the three-dimensional display device is simplified. During specific implementation, since when the modulation frequency of the liquid crystal grating is constant, the modulation period of the liquid crystal grating is determined, the length of a G subframe and/or the length of a B subframe is adjusted to change the length of an R subframe. During specific implementation, referring to FIG. 5, t₂=t₃ may be set. In addition, it is to be noted that in FIG. 5, R-on, G-on, and B-on in the third row refer to the R light, G light, and B light emitted by the backlight module (BL) respectively. Considering that the liquid crystal requires response time, the R-on is later than the scanning of the R light in the SLM (in the figure, the first R-on corresponds to the scanning of the first R light in the scanning timing of the SLM, the second G-on corresponds to the scanning of the first G light, and the second B-on corresponds to the scanning of the first B light, that is, the backlight enabling time is later than the scanning time of the sub-pixel of the corresponding color in the SLM, and the first G-on corresponds to G not shown in the previous frame). In addition, the SLM includes pixel design. R light does not transmit through a G sub-pixel and a B sub-pixel. Thus, there may be a time difference between backlight lighting time and the scanning of the SLM.

During specific implementation, there may be multiple combinations of adjusting the length of a G subframe and/or the length of a B subframe. Based on the case where the duration of an R subframe, the duration of a G subframe, and the duration of a B subframe are the same, only the length of the B subframe may be reduced, only the length of the G subframe may be reduced, the length of the G subframe and the length of the B subframe are reduced at the same time, or the length of the G subframe is increased while the length of the B subframe is reduced. A design may be performed according to actual situations during the specific implementation.

When λ₁>λ₂>λ₃,

$$\frac{Δ n ( {λ}_{1} )}{{λ}_{1}} < \frac{Δ n ( {λ}_{2} )}{{λ}_{2}} < \frac{Δ n ( {λ}_{3} )}{{λ}_{3}} .$$

Δn (λ₁) denotes the refractive index difference of the liquid crystal in the liquid crystal grating to the birefringence of the first incident light. Δn (λ₂) denotes the refractive index difference of the liquid crystal in the liquid crystal grating to the birefringence of the second incident light. An (λ₃) denotes the refractive index difference of the liquid crystal in the liquid crystal grating to the birefringence of the third incident light. The response time of the liquid crystal is shortened sequentially. FIG. 6 is a diagram of the driving principle of another three-dimensional display device according to an embodiment of the present invention. Referring to FIG. 6, In an embodiment, t₁>t₂>t₃. In this manner, it is beneficial to optimize the modulation process of the liquid crystal grating to the greatest extent. The specific duration of each subframe may be designed according to an actual liquid crystal material and a corresponding wavelength. This is not limited in the embodiments of the present invention.

In an embodiment, when the incident light is modulated, a first stage and a second stage are included. In the first stage, the drive electrode of the liquid crystal grating writes the corresponding modulation voltage. The first stage and the second stage satisfy:

$$\frac{{t}_{1 a}}{{t}_{1 b}} < \frac{{t}_{2 a}}{{t}_{2 b}} .$$

t₁ₐ denotes the duration of the first stage when the first incident light is modulated, t_{1b} denotes the duration of the second stage when the first incident light is modulated, and t_{1b}=t₁−t₁ₐ. t₂ₐ denotes the duration of the first stage when the second incident light is modulated, t_{2b} denotes the duration of the second stage when the second incident light is modulated, and t_{2b}=t₂−t₂ₐ.

When the incident light is modulated, the first stage and the second stage are included. In the first stage, the drive electrode of the liquid crystal grating writes the corresponding modulation voltage. In the second stage, the liquid crystal in the liquid crystal grating deflects in response to the modulation voltage and stabilizes for a period of time after deflection. The backlight is enabled during the time when the state is stable. For example, FIG. 7 is a diagram of the drive timing of a liquid crystal grating according to an embodiment of the present invention. Referring to FIG. 7, for example, the incident light includes first incident light a and second incident light b. When the first incident light a is modulated, the first stage is t₁ₐ, and the second stage is t_{1b}. When the second incident light b is modulated, the first stage is t₂ₐ, and the second stage is t_{2b}. When λ₁>λ₂, the response time required for the first incident light is long. Thus,

$$\frac{{t}_{1 a}}{{t}_{1 b}} < \frac{{t}_{2 a}}{{t}_{2 b}}$$

is set. In this manner, it is beneficial to reserve sufficient response time when the first incident light is modulated. During specific implementation, further referring to FIG. 7, in an embodiment, t₁ₐ=t₂ₐ, that is, when the first incident light and the second incident light are modulated, the first stage is designed to be the same, and only t_{1b} is increased. In this manner, it is beneficial to simplify the drive mode.

In an embodiment, when the incident light is modulated, the first stage and the second stage are included. In the first stage, the drive electrode of the liquid crystal grating writes the corresponding modulation voltage. The first stage and the second stage satisfy:

$$\frac{{t}_{1 a}}{{t}_{1 b}} < \frac{{t}_{2 a}}{{t}_{2 b}} < \frac{{t}_{3 a}}{{t}_{3 b}} .$$

t₁ₐ denotes the duration of the first stage when the first incident light is modulated, t_{1b} denotes the duration of the second stage when the first incident light is modulated, and t_{1b}=t₁−t₁ₐ. t₂ₐ denotes the duration of the first stage when the second incident light is modulated, t_{2b} denotes the duration of the second stage when the second incident light is modulated, and t_{2b}=t₂−t₂ₐ, t₃ₐ denotes the duration of the first stage when the third incident light is modulated. t_{3b} denotes the duration of the second stage when the third incident light is modulated, and t_{3b}=t₃−t₃ₐ.

Similar to the embodiment in FIG. 7, FIG. 8 is a diagram of the driving principle of another three-dimensional display device according to an embodiment of the present invention. Referring to FIG. 8, the first incident light, the second incident light, and the third incident light are R light, G light, and B light respectively. An R subframe includes a first stage t₁ₐ and a second stage t_{1b}. A G subframe includes a first stage t₂ₐ and a second stage t_{2b}. A B subframe includes a first stage t₃ₐ and a second stage t_{3b}.

$$\frac{{t}_{1 a}}{{t}_{1 b}} < \frac{{t}_{2 a}}{{t}_{2 b}} < \frac{{t}_{3 a}}{{t}_{3 b}}$$

is set. In this manner, it is beneficial to reserve sufficient response time when light of each color is modulated. Further referring to FIG. 8, in an embodiment, t₁ₐ=t₂ₐ=t₃ₐ. A design may be performed according to actual situations during the specific implementation.

In another embodiment, the duration of the first stage and the duration of the second stage may also be adjusted at the same time. In an embodiment, when the incident light is modulated, the first stage and the second stage are included. In the first stage, the drive electrode of the liquid crystal grating writes the corresponding modulation voltage. The first stage satisfies: t₁ₐ>t₂ₐ.

The second stage satisfies: t_{1b}>t_{2b}.

t₁ₐ denotes the duration of the first stage when the first incident light is modulated, t_{1b} denotes the duration of the second stage when the first incident light is modulated, and t_{1b}=t₁−t₁ₐ. t₂ₐ denotes the duration of the first stage when the second incident light is modulated, t_{2b} denotes the duration of the second stage when the second incident light is modulated, and t_{2b}=t₂−t₂ₐ.

For example, FIG. 9 is a diagram of the drive timing of a liquid crystal grating according to an embodiment of the present invention. Referring to FIG. 9, in this embodiment, t₁ₐ>t₂ₐ is set. When λ₁>λ₂, the drive voltage range loaded when the first incident light is modulated is often greater than the loaded voltage range when the second incident light is modulated. The liquid crystal grating includes multiple electrode groups. The greater the loaded voltage is, the stronger the coupling effect between electrodes is. Thus, t₁ₐ>t₂ₐ is set. When the first incident light is modulated, the drive voltage may be written more times to weaken the coupling effect. t_{1b}>t_{2b} is set. In this manner, it is beneficial to reserve sufficient response time when the first incident light is modulated.

In an embodiment, when the incident light is modulated, the first stage and the second stage are included. In the first stage, the grating electrode of the liquid crystal grating writes the corresponding modulation voltage. The first stage satisfies: t₁ₐ>t₂ₐ≥t₃ₐ.

The second stage satisfies: t_{1b}>t_{2b}≥t_{3b}.

t₁ₐ denotes the duration of the first stage when the first incident light is modulated, t_{1b} denotes the duration of the second stage when the first incident light is modulated, and t_{1b}=t₁−t₁ₐ. t₂ₐ denotes the duration of the first stage when the second incident light is modulated, t_{2b} denotes the duration of the second stage when the second incident light is modulated, and t_{2b}=t₂−t₂ₐ. t₃ₐ denotes the duration of the first stage when the third incident light is modulated, t_{3b} denotes the duration of the second stage when the third incident light is modulated, and t_{3b}=t₃−t₃ₐ.

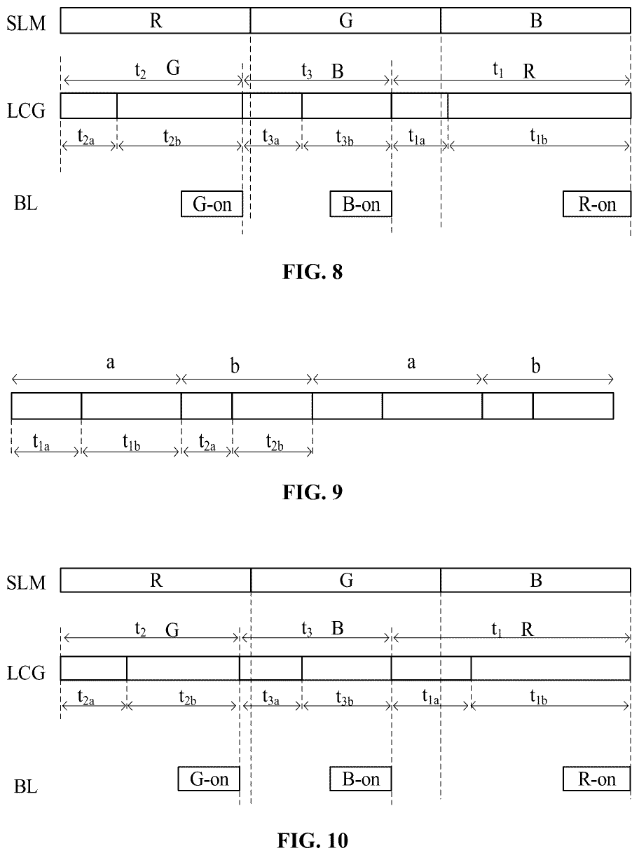

Similar to the embodiment in FIG. 9, FIG. 10 is a diagram of the driving principle of another three-dimensional display device according to an embodiment of the present invention. Referring to FIG. 10, the first incident light, the second incident light, and the third incident light are R light, G light, and B light respectively. An R subframe includes a first stage t₁ₐ and a second stage t_{1b}. A G subframe includes a first stage t₂ₐ and a second stage t_{2b}. A B subframe includes a first stage t₃ₐ and a second stage t_{3b}. In this embodiment, t₁ₐ>t₂ₐ≥t₃ₐ and t_{1b}>t_{2b}≥t_{3b} are set. At the same time, the design of the time of the first stage and the time of the second stage is optimized to implement the better driving effect.

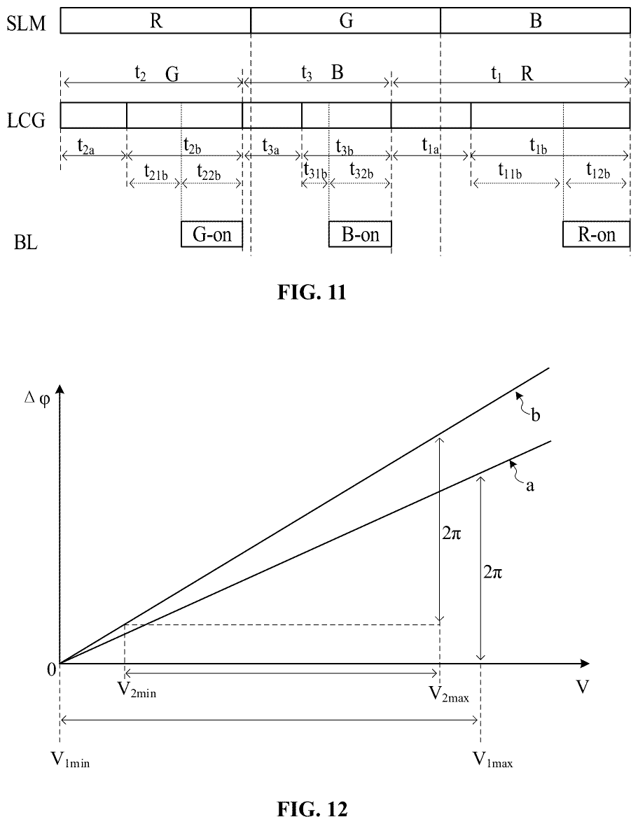

FIG. 11 is a diagram of the driving principle of another three-dimensional display device according to an embodiment of the present invention. Referring to FIG. 11, the second stage t_{1b} in the R subframe includes a first sub-stage t_{11b} and a second sub-stage t_{12b}. The second stage t_{2b} in the G subframe includes a first sub-stage t_{21b} and a second sub-stage t_{22b}. The second stage t_{3b} in the B subframe includes a first sub-stage t_{31b} and a second sub-stage t_{32b}. The first sub-stage t_{11b}, the first sub-stage t_{21b}, and the first sub-stage t_{31b} are the response time of liquid crystal deflection after drive voltage is loaded when R light is modulated, the response time of liquid crystal deflection after drive voltage is loaded when G light is modulated, and the response time of liquid crystal deflection after drive voltage is loaded when B light is modulated respectively. The second sub-stage t_{12b}, the second sub-stage t_{22b}, and the second sub-stage t_{32b} correspond to the lighting time of R backlight, the lighting time of G backlight, and the lighting time of B backlight respectively. It is to be noted that the second stage includes two periods of liquid crystal deflection and liquid crystal state stabilization. When backlight is enabled, the liquid crystal is in a stable state. In this embodiment, the enabling duration of backlight (that is, the length of R-on, the length of G-on, and the length of B-on) is the same, and the disabling moment of the backlight is the same as the start moment when the LCG modulates the next wavelength (for example, the end moment of G-on is the same as the start moment of t₃, which is also the latest end moment of the backlight). In other words, in this embodiment, the length of the liquid crystal deflection period corresponding to t_{11b}, the length of the liquid crystal deflection period corresponding to t_{21b}, and the length of the liquid crystal deflection period corresponding to t_{31b} are set to be different, and t_{12b}=t_{22b}=t_{32b}. In this manner, it is beneficial to simplify the drive timing. In other embodiments, the length of the enabling time of different backlight may also be set to be different. For example, the disabling moment of the backlight may be earlier than this embodiment by a certain time. A design may be performed according to actual situations during the specific implementation.

On the basis of the preceding embodiment, the liquid crystal grating includes multiple grating groups. Each grating group includes multiple drive electrodes. When the liquid crystal grating modulates the incident light, the multiple drive electrodes in the same grating group load a gradient voltage.

The voltage loaded by the drive electrodes satisfies: V₁ₘᵢₙ<V₂ₘᵢₙ.

V₁ₘᵢₙ denotes the minimum voltage loaded by the drive electrodes when the first incident light is modulated. V₂ₘᵢₙ denotes the minimum voltage loaded by the drive electrodes when the second incident light is modulated.

Each grating group corresponds to one grating period of the liquid crystal grating. The gradient voltage (the gradient voltage may be linear, and this is not limited in this embodiment of the present invention) is applied to multiple drive electrodes in one grating group, and the phase of the liquid crystal in the grating period may be controlled to change from 0 to 2π. For example, FIG. 12 is a diagram of a gradient voltage range loaded by a drive electrode according to an embodiment of the present invention. The center wavelength λ₁ of the first incident light a is greater than the center wavelength λ₂ of the second incident light b. The gradient voltage range required for modulating the first incident light a is greater than the gradient voltage range required for modulating the second incident light b. V₁ₘᵢₙ<V₂ₘᵢₙ is set, that is, a voltage for modulating the second incident light b is increased. In this manner, it is beneficial to improve the response speed of liquid crystals. In FIG. 12, the horizontal axis represents a voltage V, and the vertical axis represents the phase change Δφ of the liquid crystal.

It is to be noted that V₁ₘᵢₙ=0 shown in FIG. 12 is merely an example and is not a limitation to this embodiment of the present invention. A design may be performed according to actual situations during the specific implementation. In this embodiment of the present invention, there is no limitation on the maximum value V₁ₘₐₓ and the maximum value V₂ₘₐₓ of the two voltages. In an embodiment, the maximum voltage V₁ₘₐₓ loaded by the drive electrodes when the first incident light is modulated is the same as or different from the maximum voltage V₂ₘₐₓ loaded by the drive electrodes when the second incident light is modulated. V₁ₘₐₓ may be set equal to V₂ₘₐₓ. V₁ₘₐₓ may also be set greater or less than V₂ₘₐₓ.

In an embodiment, the liquid crystal grating includes multiple grating groups. Each grating group includes multiple drive electrodes. When the liquid crystal grating modulates the incident light, the multiple drive electrodes in the same grating group load the gradient voltage.

The voltage loaded by the drive electrodes satisfies: V₁ₘᵢₙ<V₂ₘᵢₙ<V₃ₘᵢₙ.

V₁ₘᵢₙ denotes the minimum voltage loaded by the drive electrodes when the first incident light is modulated. V₂ₘᵢₙ denotes the minimum voltage loaded by the drive electrodes when the second incident light is modulated. V₃ₘᵢₙ denotes the minimum voltage loaded by the drive electrodes when the third incident light is modulated.

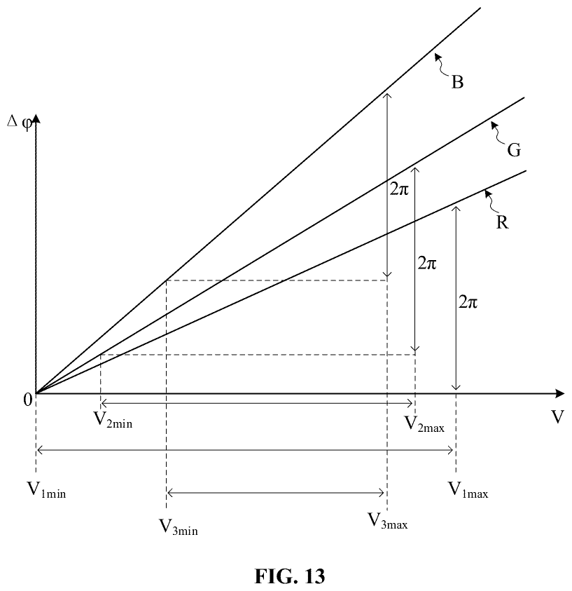

FIG. 13 is a diagram of another gradient voltage range loaded by a drive electrode according to an embodiment of the present invention. The first incident light, the second incident light, and the third incident light may be R light, G light, and B light respectively. Since the gradient voltage range corresponding to the R light, the gradient voltage range corresponding to the G light, and the gradient voltage range corresponding to the B light decrease sequentially, for a GB subframe, a minimum voltage greater than 0 V may be selected, for example, V₁ₘᵢₙ<V₂ₘᵢₙ<V₃ₘᵢₙ, so that the liquid crystal response speed is accelerated. V₁ₘᵢₙ=0 shown in FIG. 13 is merely an example embodiment and is not a limitation to this embodiment of the present invention. During specific implementation, in an embodiment, at least two of the maximum voltage V₁ₘₐₓ loaded by the drive electrodes when the first incident light is modulated, the maximum voltage V₂ₘₐₓ loaded by the drive electrodes when the second incident light is modulated, and the maximum voltage V₃ₘₐₓ loaded by the drive electrodes when the third incident light is modulated are the same or different. This is not limited in this embodiment of the present invention. In FIG. 13, the horizontal axis represents a voltage V, and the vertical axis represents the phase change Δφ of the liquid crystal.

In the preceding embodiment, different modulation duration is set to change the voltage of a drive electrode, or the voltage of the drive electrode is changed based on the different modulation duration, in another embodiment, that is, the voltage of the drive electrode is changed. In an embodiment, the liquid crystal grating includes multiple grating groups. Each grating group includes multiple drive electrodes. When the liquid crystal grating modulates the incident light, the multiple drive electrodes in the same grating group load the gradient voltage.

The first incident light and the second incident light satisfy: λ₁>λ₂.

The voltage loaded by the drive electrodes satisfies: V₁ₘᵢₙ<V₂ₘᵢₙ.

λ₁ denotes the center wavelength of the first incident light. λ₂ denotes the center wavelength of the second incident light. V₁ₘᵢₙ denotes the minimum voltage loaded by the drive electrodes when the first incident light is modulated. V₂ₘᵢₙ denotes the minimum voltage loaded by the drive electrodes when the second incident light is modulated.

In an embodiment, the modulation duration satisfies: t₁=t₂.

t₁ denotes the modulation duration for modulating the first incident light. t₂ denotes the modulation duration for modulating the second incident light.

In an embodiment, the incident light includes first incident light, second incident light, and third incident light. The first incident light, the second incident light, and the third incident light satisfy: λ₁>λ₂>λ₃.

The voltage loaded by the drive electrodes satisfies: V₁ₘᵢₙ<V₂ₘᵢₙ<V₃ₘᵢₙ.

λ₁ denotes the center wavelength of the first incident light. λ₂ denotes the center wavelength of the second incident light. k 3 denotes the center wavelength of the third incident light. V₁ₘᵢₙ denotes the minimum voltage loaded by the drive electrodes when the first incident light is modulated. V₂ₘᵢₙ denotes the minimum voltage loaded by the drive electrodes when the second incident light is modulated. V₃ₘᵢₙ denotes the minimum voltage loaded by the drive electrodes when the third incident light is modulated.

In an embodiment, the modulation duration satisfies: t₁=t₂=t₃.

t₁ denotes the modulation duration for modulating the first incident light. t₂ denotes the modulation duration for modulating the second incident light. t₃ denotes the modulation duration for modulating the third incident light.

An embodiment in which only the voltage of a drive electrode is adjusted is similar to the preceding embodiment, and the details are not repeated here.

An embodiment of the present invention provides a driving method of a liquid crystal grating. The method is applied to any liquid crystal grating provided in the preceding embodiments. The liquid crystal grating includes multiple grating groups. Each grating group includes multiple drive electrodes. An odd-numbered drive electrode in the same grating group is connected to a first signal terminal. An even-numbered drive electrode is connected to a second signal terminal. Each drive electrode is connected to a corresponding drive voltage terminal.

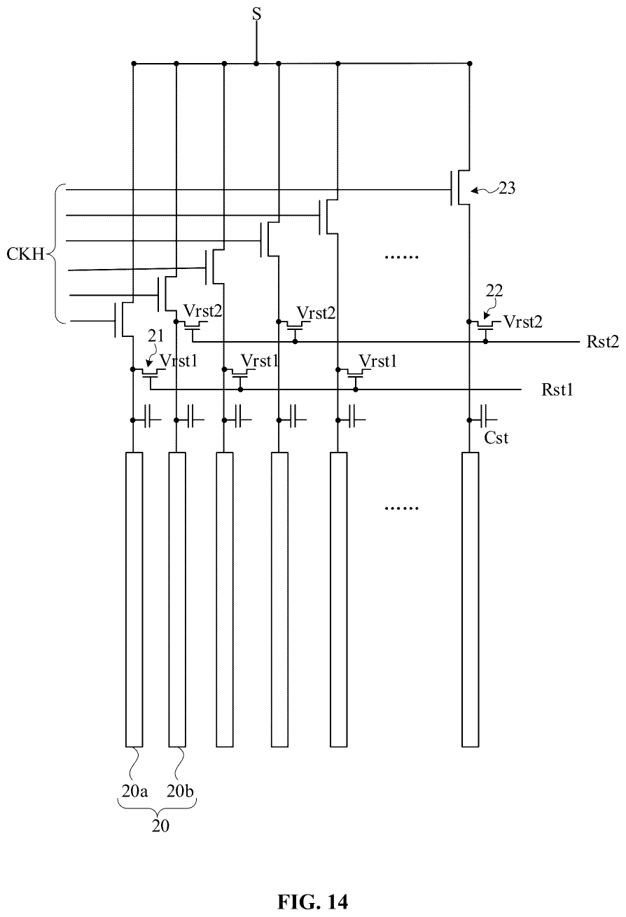

For example, FIG. 14 is a diagram of the circuit principle of a grating group according to an embodiment of the present invention. Referring to FIG. 14, in an embodiment, a grating group includes multiple drive electrodes 20 (in FIG. 14, 6 drive electrodes 20 are exemplarily shown, and this is not a limitation to this embodiment of the present invention). The grating group includes multiple first transistors 21 and multiple second transistors 22. A first terminal of a first transistor 21 is connected to an odd-numbered drive electrode 20a in the same grating group. A second terminal of the first transistor 21 is connected to a first signal terminal Vrst1. The control terminal of the first transistor 21 is connected to a first control signal terminal Rst1. A first terminal of a second transistor 22 is connected to an even-numbered drive electrode 20a in the same grating group. A second terminal of the second transistor 22 is connected to a second signal terminal Vrst2. The control terminal of the second transistor 22 is connected to a second control signal terminal Rst2. For the stability of the loaded voltage, each drive electrode 20 is connected in parallel with a capacitor Cst.

When the incident light is modulated, the first stage in which the corresponding modulation voltage is written to the drive electrodes is included. The first stage includes a precharge stage and a gradient voltage write stage. The driving method provided by this embodiment of the present invention includes the steps below.

In the precharge stage, the first signal terminal Vrst1 applies a first precharge voltage to the corresponding drive electrode, and the second signal terminal Vrst2 applies a second precharge voltage to the corresponding drive electrode.

That is, in the precharge stage, the first control signal terminal Rst1 controls the first transistor 21 to be on, and the first signal terminal Vrst1 applies the first precharge voltage to the corresponding drive electrode. The second control signal terminal Rst2 controls the second transistor 22 to be on, and the second signal terminal Vrst2 applies the second precharge voltage to the corresponding drive electrode. The first precharge voltage is the same as the second precharge voltage and is the same as the minimum voltage of the gradient voltage.

Further referring to FIG. 14, in an embodiment, a grating group corresponds to a drive voltage terminal S. The grating group also includes multiple third transistors 23. A first terminal of a third transistor 23 is connected to a drive electrode 20. A second terminal of the third transistor 23 is connected to the drive voltage terminal S. The control terminal of the third transistor 20 is connected to a timing signal terminal CKH. In the gradient voltage write stage, the drive voltage terminal S applies the gradient voltage to the corresponding drive electrode. In this stage, the first control signal terminal Rst1 controls the first transistor 21 to be off. The second control signal terminal Rst2 controls the second transistor 22 to be off. The timing signal terminal CKH controls the third transistor to be on sequentially. The drive voltage terminal S loads a drive voltage for the corresponding drive electrode. The drive voltage terminal S loads a drive voltage for the corresponding drive electrode. In other embodiments, the drive voltage terminal may also be configured to be in one-to-one correspondence with the corresponding driver electrode. It is also possible to design different numbers of drive electrodes in different grating groups according to actual requirements. A design may be performed according to actual situations during the specific implementation.

In an embodiment, when the incident light is adjusted, a reset stage is also included. In the reset stage, the first signal terminal Vrst1 applies a first reset voltage to the corresponding drive electrode. The second signal terminal Vrst2 applies a second reset voltage to the corresponding drive electrode. That is, in the reset stage, the first control signal terminal Rst1 controls the first transistor 20 to be on. The first signal terminal Vrst1 applies the first reset voltage to the corresponding drive electrode. The second control signal terminal Rst2 controls the second transistor 22 to be on. The second signal terminal Vrst2 applies the second reset voltage to the corresponding drive electrode. The polarity of the first reset voltage is opposite to the polarity of the second reset voltage. When the incident light is adjusted, the reset stage, the precharge stage, and the gradient voltage write stage that are sequentially executed are included. Alternatively, when the incident light is adjusted, the precharge stage, the gradient voltage write stage, and the reset stage that are sequentially executed are included. The reset stage is configured to eliminate the influence of the liquid crystal deflection of the previous frame.

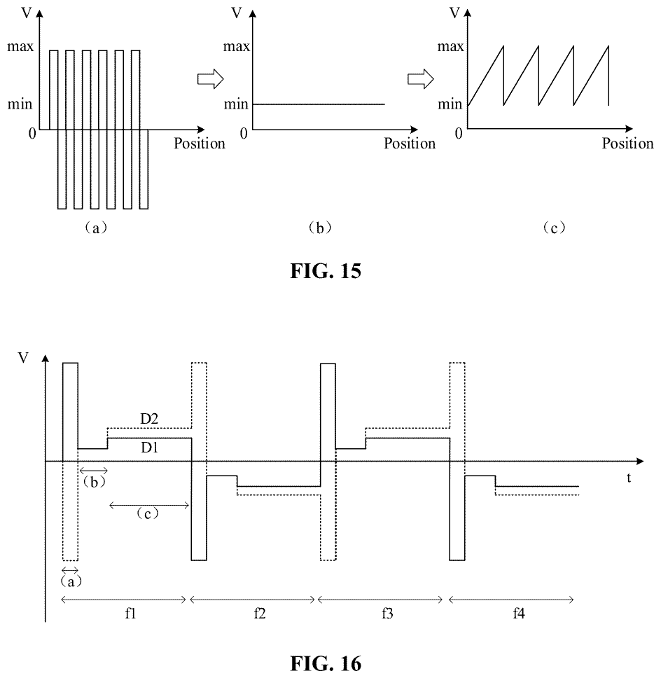

For example, when the incident light is adjusted, the reset stage, the precharge stage, and the gradient voltage write stage that are sequentially executed are included. FIG. 15 is a principle diagram of loading a voltage by a liquid crystal grating according to an embodiment of the present invention. FIG. 16 is a timing diagram of loading a voltage by a liquid crystal grating according to an embodiment of the present invention. Referring to FIG. 15, in the figure, the abscissa is a position, and the ordinate is a voltage V. In figure (a), one voltage reversal corresponds to one electrode. In figure (c), the voltages from min to max correspond to a grating group. Referring to FIG. 16, FIG. 16 schematically shows four subframes f1˜f4 and two drive electrodes D1 and D2 loaded with gradient voltages. In the figure, the abscissa is time t, and the ordinate is a voltage V. The second stage of incident modulation is omitted, that is, the liquid crystal response and holding time. One of the subframes includes a reset stage (a), a precharge stage (b), and a gradient voltage write stage (c). In other embodiments, the reset stage may be located after the gradient voltage write stage and may be selected according to actual situations during the specific implementation.

Further referring to FIG. 16, in an embodiment, in two adjacent modulation duration (that is, two adjacent subframes), the polarity of each power-on signal is opposite. The polarities of the power-on signals of two adjacent subframes are configured to be reversed, so that it is possible to prevent the liquid crystal from being scheduled by the same drive voltage for a long time, which affects the driving effect.

In an embodiment, the voltage value of the first reset voltage and the voltage value of the second reset voltage are the same as the maximum voltage value of the gradient voltage. The maximum gradient voltage is directly used as the reset voltage to ensure the reset effect. The reset voltage terminal may also be shared with the drive voltage terminal to simplify the circuit structure.

An embodiment of the present invention provides a three-dimensional display device. The device includes a backlight module, a spatial light modulator, and any liquid crystal grating provided by the preceding embodiments that are sequentially stacked. The backlight module is configured to provide field-sequential collimation coherent backlight required for three-dimensional display. The spatial light modulator is configured to modulate the phase and the amplitude of the field-sequential collimation coherent backlight. The liquid crystal grating is configured to modulate the light beam output by the spatial light modulator into a first direction light beam and a second direction light beam and output the first direction light beam and the second direction light beam.

During specific implementation, the backlight module includes a light source that emits three-color light of R light, G light, and B light. The spatial light modulator may include a phase liquid crystal spatial light modulator and an amplitude spatial light phase modulator. The liquid crystal grating may include one 0-degree liquid crystal grating and two 45-degree liquid crystal gratings. The first direction and the second direction are transmitted to the left eye and the right eye of a user separately. In other embodiments, a convergence field lens disposed between the spatial light modulator and the liquid crystal grating may also be included. Since the three-dimensional display device provided by this embodiment of the present invention includes any liquid crystal grating provided by the preceding embodiments, the device has the same technical effects or corresponding technical effects of the liquid crystal grating, and the details are not repeated here.

It is to be noted that the preceding are only preferred embodiments of the present invention and the technical principles used therein. It is to be understood by those skilled in the art that the present invention is not limited to the embodiments described herein. For those skilled in the art, various apparent modifications, adaptations, combinations, and substitutions can be made without departing from the scope of the present invention. Therefore, while the present invention is described in detail in connection with the preceding embodiments, the present invention is not limited to the preceding embodiments and may include equivalent embodiments without departing from the concept of the present invention. The scope of the present invention is determined by the scope of the appended claims.

What is claimed is:

1. A liquid crystal grating, configured to modulate incident light and output deflected emitted light, wherein
the incident light comprises at least first incident light and second incident light, first emitted light is output after the first incident light is modulated by the liquid crystal grating, second emitted light is output after the second incident light is modulated by the liquid crystal grating, and a light wave segment of the first incident light and a light wave segment of the second incident light do not overlap at least partially; and
when the liquid crystal grating modulates the first incident light and the second incident light, at least one of a minimum value of a modulation voltage corresponding to the first incident light and a minimum value of a modulation voltage corresponding to the second incident light or modulation duration corresponding to the first incident light and modulation duration corresponding to the second incident light is different.

2. The liquid crystal grating according to claim 1, wherein a modulation period of the liquid crystal grating comprises a plurality of subframes, and modulation duration of the incident light corresponds to duration of one of the plurality of subframes, wherein an end moment of an Nth subframe of the plurality of subframes is the same as a start moment of an (N+1)th subframe of the plurality of subframes, and N is an integer ≥2.

3. The liquid crystal grating according to claim 1, wherein the first incident light and the second incident light satisfy:
λ₁>λ₂; and
the modulation duration satisfies:
t₁>t₂,
wherein λ₁ denotes a center wavelength of the first incident light, λ₂ denotes a center wavelength of the second incident light, t₁ denotes modulation duration for modulating the first incident light, and t₂ denotes modulation duration for modulating the second incident light.

4. The liquid crystal grating according to claim 3, wherein when the incident light is modulated, a first stage and a second stage are comprised, in the first stage, a drive electrode of the liquid crystal grating writes a corresponding modulation voltage, and the first stage and the second stage satisfy:
$$\frac{{t}_{1 a}}{{t}_{1 b}} < \frac{{t}_{2 a}}{{t}_{2 b}} ,$$
wherein t₁ₐ denotes duration of the first stage when the first incident light is modulated, t_{1b} denotes duration of the second stage when the first incident light is modulated, t_{1b}=t₁−t₁ₐ, t₂ₐ denotes duration of the first stage when the second incident light is modulated, t_{2b} denotes duration of the second stage when the second incident light is modulated, and t_{2b}=t₂−t₂ₐ.

5. The liquid crystal grating according to claim 4, wherein t₁ₐ=t₂ₐ.

6. The liquid crystal grating according to claim 3, wherein when the incident light is modulated, a first stage and a second stage are comprised, in the first stage, a drive electrode of the liquid crystal grating writes the corresponding modulation voltage, and the first stage satisfies:
t₁ₐ>t₂ₐ; and
the second stage satisfies:
t_{1b}>t_{2b},
wherein t₁ₐ denotes duration of the first stage when the first incident light is modulated, t_{1b} denotes duration of the second stage when the first incident light is modulated, t_{1b}=t₁−t₁ₐ, t₂ₐ denotes duration of the first stage when the second incident light is modulated, t_{2b} denotes duration of the second stage when the second incident light is modulated, and t_{2b}=t₂−t₂ₐ.

7. The liquid crystal grating according to claim 3, wherein the incident light comprises the first incident light, the second incident light, and third incident light, and the first incident light, the second incident light, and the third incident light satisfy:
λ₁>λ₂>λ₃; and
the modulation duration satisfies:
t₁>t₂, and t₁>t₃,
wherein λ₁ denotes the center wavelength of the first incident light, λ₂ denotes the center wavelength of the second incident light, λ₃ denotes a center wavelength of the third incident light, t₁ denotes the modulation duration for modulating the first incident light, t₂ denotes the modulation duration for modulating the second incident light, and t₃ denotes modulation duration for modulating the third incident light.

8. The liquid crystal grating according to claim 7, wherein t₁>t₂>t₃.

9. The liquid crystal grating according to claim 8, wherein when the incident light is modulated, a first stage and a second stage are comprised, in the first stage, a drive electrode of the liquid crystal grating writes the corresponding modulation voltage, and the first stage and the second stage satisfy:
$$\frac{{t}_{1 a}}{{t}_{1 b}} < \frac{{t}_{2 a}}{{t}_{2 b}} < \frac{{t}_{3 a}}{{t}_{3 b}} ,$$
wherein t₁ₐ denotes duration of the first stage when the first incident light is modulated, t_{1b} denotes duration of the second stage when the first incident light is modulated, t_{1b}=t₁−t₁ₐ, t₂ₐ denotes duration of the first stage when the second incident light is modulated, t_{2b} denotes duration of the second stage when the second incident light is modulated, and t_{2b}=t₂−t₂ₐ, t₃ₐ denotes duration of the first stage when the third incident light is modulated, t_{3b} denotes duration of the second stage when the third incident light is modulated, and t_{3b}=t₃−t₃ₐ.

10. The liquid crystal grating according to claim 9, wherein t₁ₐ=t₂ₐ=t₃ₐ.

11. The liquid crystal grating according to claim 8, wherein when the incident light is modulated, a first stage and a second stage are comprised, in the first stage, a grating electrode of the liquid crystal grating writes the corresponding modulation voltage, and the first stage satisfies:
t₁ₐ>t₂ₐ≥t₃ₐ; and
the second stage satisfies:
t_{1b}>t_{2b}≥t_{3b},
wherein t₁ₐ denotes duration of the first stage when the first incident light is modulated, t_{1b} denotes duration of the second stage when the first incident light is modulated, t_{1b}=t₁−t₁ₐ, t₂ₐ denotes duration of the first stage when the second incident light is modulated, t_{2b} denotes duration of the second stage when the second incident light is modulated, t_{2b}=t₂−t₂ₐ, t₃ₐ denotes duration of the first stage when the third incident light is modulated, t_{3b} denotes duration of the second stage when the third incident light is modulated, and t_{3b}=t₃−t₃ₐ.

12. The liquid crystal grating according to claim 3, wherein the liquid crystal grating comprises a plurality of grating groups, each of the plurality of grating groups comprises a plurality of drive electrodes, and when the liquid crystal grating modulates the incident light, the plurality of drive electrodes in a same grating group load a gradient voltage; and
the voltage loaded by the plurality of drive electrodes satisfies:
V₁ₘᵢₙ<V₂ₘᵢₙ,
wherein V₁ₘᵢₙ denotes a minimum voltage loaded by the plurality of drive electrodes when the first incident light is modulated, and V₂ₘᵢₙ denotes a minimum voltage loaded by the plurality of drive electrodes when the second incident light is modulated.

13. The liquid crystal grating according to claim 12, wherein a maximum voltage V₁ₘₐₓ loaded by the plurality of drive electrodes when the first incident light is modulated is the same as or different from a maximum voltage V₂ₘₐₓ loaded by the plurality of drive electrodes when the second incident light is modulated.

14. The liquid crystal grating according to any one of claims 7, wherein the liquid crystal grating comprises a plurality of grating groups, each of the plurality of grating groups comprises a plurality of drive electrodes, and when the liquid crystal grating modulates the incident light, the plurality of drive electrodes in a same grating group of the plurality of grating groups load a gradient voltage; and
the voltage loaded by the plurality of drive electrodes satisfies:
V₁ₘᵢₙ<V₂ₘᵢₙ<V₃ₘᵢₙ,
wherein V₁ₘᵢₙ denotes a minimum voltage loaded by the plurality of drive electrodes when the first incident light is modulated, V₂ₘᵢₙ denotes a minimum voltage loaded by the plurality of drive electrodes when the second incident light is modulated, and V₃ₘᵢₙ denotes a minimum voltage loaded by the plurality of drive electrodes when the third incident light is modulated.

15. The liquid crystal grating according to claim 1, wherein the liquid crystal grating comprises a plurality of grating groups, each of the plurality of grating groups comprises a plurality of drive electrodes, and when the liquid crystal grating modulates the incident light, the plurality of drive electrodes in a same grating group of the plurality of grating groups load a gradient voltage;
the first incident light and the second incident light satisfy:
λ₁>λ₂; and
the voltage loaded by the plurality of drive electrodes satisfies:
V₁ₘᵢₙ<V₂ₘᵢₙ,
wherein λ₁ denotes a center wavelength of the first incident light, λ₂ denotes a center wavelength of the second incident light, V₁ₘᵢₙ denotes a minimum voltage loaded by the plurality of drive electrodes when the first incident light is modulated, and V₂ₘᵢₙ denotes a minimum voltage loaded by the plurality of drive electrodes when the second incident light is modulated;
wherein the modulation duration satisfies:
t₁=t₂,
wherein t₁ denotes modulation duration for modulating the first incident light, and t₂ denotes modulation duration for modulating the second incident light.

16. A driving method of a liquid crystal grating, the method being applied to a liquid crystal grating configured to modulate incident light and output deflected emitted light, wherein
the incident light comprises at least first incident light and second incident light, first emitted light is output after the first incident light is modulated by the liquid crystal grating, second emitted light is output after the second incident light is modulated by the liquid crystal grating, and a light wave segment of the first incident light and a light wave segment of the second incident light do not overlap at least partially; and
when the liquid crystal grating modulates the first incident light and the second incident light, at least one of a minimum value of a modulation voltage corresponding to the first incident light and a minimum value of a modulation voltage corresponding to the second incident light or modulation duration corresponding to the first incident light and modulation duration corresponding to the second incident light is different;
wherein the liquid crystal grating further comprises a plurality of grating groups, each of the plurality of grating groups comprises a plurality of drive electrodes, an odd-numbered drive electrode of the plurality of drive electrodes in a same grating group of the plurality of grating groups is connected to a first signal terminal, an even-numbered drive electrode of the plurality of drive electrodes is connected to a second signal terminal, and each of the plurality of drive electrodes is connected to a corresponding drive voltage terminal;
when the incident light is modulated, a first stage in which the corresponding modulation voltage is written to the plurality of drive electrodes is comprised, and the first stage comprises a precharge stage and a gradient voltage write stage; and
the driving method comprises:
in the precharge stage, applying, by the first signal terminal, a first precharge voltage to the corresponding drive electrode, and applying, by the second signal terminal, a second precharge voltage to the corresponding drive electrode; and
in the gradient voltage write stage, applying, by the drive voltage terminal, a gradient voltage to the corresponding drive electrode,
wherein the first precharge voltage is the same as the second precharge voltage and is the same as a minimum voltage of the gradient voltage.

17. The drive method according to claim 16, wherein when the incident light is modulated, a reset stage is further comprised, in the reset stage, the first signal terminal applies a first reset voltage to the corresponding drive electrode, and the second signal terminal applies a second reset voltage to the corresponding drive electrode, and a polarity of the first reset voltage is opposite to a polarity of the second reset voltage; and
when the incident light is modulated, the reset stage, the precharge stage, and the gradient voltage write stage that are sequentially executed are comprised, or when the incident light is modulated, the precharge stage, the gradient voltage write stage, and the reset stage that are sequentially executed are comprised.

18. The drive method according to claim 17, wherein in two adjacent modulation duration, a polarity of each power-on signal is opposite.

19. The drive method according to claim 17, wherein a voltage value of the first reset voltage and a voltage value of the second reset voltage are the same as a maximum voltage value of the gradient voltage.

20. A three-dimensional display device, comprising a backlight module, a spatial light modulator, and a liquid crystal grating that are sequentially stacked, wherein the liquid crystal grating is configured to modulate incident light and the incident light comprises at least first incident light and second incident light, first emitted light is output after the first incident light is modulated by the liquid crystal grating, second emitted light is output after the second incident light is modulated by the liquid crystal grating, and a light wave segment of the first incident light and a light wave segment of the second incident light do not overlap at least partially; and
when the liquid crystal grating modulates the first incident light and the second incident light, at least one of a minimum value of a modulation voltage corresponding to the first incident light and a minimum value of a modulation voltage corresponding to the second incident light or modulation duration corresponding to the first incident light and modulation duration corresponding to the second incident light is different; and
wherein the backlight module is configured to provide field-sequential collimation coherent backlight required for three-dimensional display;
the spatial light modulator is configured to modulate a phase and an amplitude of the field-sequential collimation coherent backlight; and
the liquid crystal grating is configured to modulate a light beam output by the spatial light modulator into a first direction light beam and a second direction light beam and output the first direction light beam and the second direction light beam.
